(19) United States
(12) Patent Application Publication
(10) Pub. No.: US 2025/0056499 A1
(43) Pub. Date: Feb. 13, 2025

(54) PAGING A USER DEVICE IN A NON-TERRESTRIAL NETWORK

(71) Applicant: Nokia Technologies Oy, Espoo (FI)

(72) Inventors: Jeroen WIGARD, Klarup (DK); Rafhael MEDEIROS DE AMORIM, Aalborg (DK)

(21) Appl. No.: 18/719,884

(22) PCT Filed: Dec. 15, 2021
(86) PCT No.: PCT/EP2021/085937

§ 371 Date: Jun. 14, 2024

(51) Int. Cl. H04W 68/02; H04W 74/0833; H04W 76/15; H04W 84/06

(52) U.S. Cl. CPC H04W 68/02; H04W 74/0833; H04W 76/15; H04W 84/06

(57) ABSTRACT

Various example embodiments relate to a solution for non-terrestrial network communication. A user device for non-terrestrial network communication may be configured to receive a paging message from a first network device of a first non-terrestrial network; and in response to the paging message, initiate a random access procedure with a second network device associated with a second non-terrestrial network to establish a radio resource connection with the second network device. Network devices, methods and computer-programs are also provided.

### TECHNICAL FIELD

Various example embodiments generally relate to the field of wireless data communications. In particular, some example embodiments relate to a solution for non-terrestrial communication.

### BACKGROUND

Non-terrestrial networks comprise networks that may use an airborne or spaceborne platform as a part of the network, such as satellites, high-altitude platforms or drones. Satellites can be classified in terms of their altitude, from low-Earth orbit (LEO) to geostationary Earth orbit (GEO) satellites. LEO satellites are deployed in large constellations and move with respect to the Earth's surface with a speed of approximately 7, 5 km/s to maintain their orbit. An advantage of the LEO satellites is global and high-speed communication with a low delay in comparison to traditional GEO satellites due to the lower round-trip time (RTT). As the LEO satellites move with respect to the Earth, this will lead to very frequent handovers, even if a user equipment (UE) served by the LEO satellites is not moving.

A challenge associated with GEO satellites is the distance from Earth (approx. 36000 km) leading to large delays and a poor link budget. Especially, an achievable throughput, for example, for a handheld user equipment (UE), which can only use a limited transmit power, is the most challenging caused, for example, by the limited UE power. Reaching a GEO satellite with the UE may be difficult or even impossible.

A challenge associated with the LEO may be that the LEO satellites are moving fast relative to Earth (7.5 km/s). This entails the coverage on Earth is changing with the movement of the satellite. This also means that UEs on Earth will experience very frequent mobility events in both active (handovers) and inactive (cell reselections) mode. A problem caused by this is the power consumption. A UE in idle mode experiences a cell reselection about every 7 seconds if the cell radius is 50 km. At every cell reselection the UE needs to read the system information of the new cell. For UEs not being active this increases the overall energy consumption considerably. Moreover, it may require active frequency synchronization and “signal chasing” (angle of arrival, Doppler frequency, timing) effort from the UE to keep tracking the paging opportunities over time.

With Earth fixed cells provided by, for example, LEO satellites, a cell coverage may be kept constant for as long as possible by steering the satellite beam to the same spot on Earth. When this is not possible any more, a new satellite will take over the same spot. Although, in view of a UE, the amount of handovers may decrease compared to the Earth moving solution, there will still be mobility events.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may provide a solution that allows paging a second non-terrestrial network, for example, a LEO network, through a first non-terrestrial network, for example, a GEO network. This benefit may be achieved by the features of the independent claims. Further implementation forms are provided in the dependent claims, the description, and the drawings.

According to a first aspect, a user device for non-terrestrial network communication may comprise at least one processor and at least one memory including computer program code. The at least one memory and the computer program code are configured to, with the at least one processor, cause the user device at least to: receive a paging message from a first network device associated; and in response to the paging message, initiate a random access procedure with a second network device associated with a second non-terrestrial network to establish a radio resource connection with the second network device.

In an example embodiment, the at least one memory and the computer program code are configured to, with the at least one processor, cause the user device at least to: before terminating the radio resource connection with the second network device, receive information identifying a cell of the first non-terrestrial network from the second network device; terminate the radio resource connection with the second network device; and monitor paging messages of the cell of the first non-terrestrial network.

In an example embodiment, the paging message comprises an indication of at least one cell of the second non-terrestrial network.

In an example embodiment, the at least one memory and the computer program code are configured to, with the at least one processor, cause the user device at least to, in response to receiving the paging message, obtain preconfigured information about the second network device with which to initiate the random access procedure.

In an example embodiment, the first non-terrestrial network is based on geostationary Earth orbit satellites and the second non-terrestrial network is based on low-Earth orbit satellites.

According to a second aspect, a first network device of a first non-terrestrial network may comprise at least one processor and at least one memory including computer program code. The at least one memory and the computer program code are configured to, with the at least one processor, cause the first network device at least to: transmit information identifying a user device to a second network device of a second non-terrestrial network; and transmit a paging message to the user device, the paging message causing the user device to initiate a random access procedure with the second network device.

In an example embodiment, the paging message comprises an indication of at least one cell of the second non-terrestrial network.

In an example embodiment, the at least one memory and the computer program code are configured to, with the at least one processor, cause the first network device at least to receive, from a core network, mapping information providing a mapping between a tracking area of the first non-terrestrial network and tracking areas of the second non-terrestrial network; and transmit the mapping information to the user device.

In an example embodiment, the first non-terrestrial network is based on geostationary Earth orbit satellites and the second non-terrestrial network is based on low-Earth orbit satellites.

According to a third aspect, a second network device of a second non-terrestrial network may comprise at least one processor and at least one memory including computer program code. The at least one memory and the computer program code are configured to, with the at least one processor, cause the second network device at least to: receive, from a first network device of a first non-terrestrial network, information identifying a user device; obtain user plane data associated with the user device; receive a random access procedure request from the user device to establish a radio resource connection with the user device; and transmit a random access procedure response to the user device.

In an example embodiment, the at least one memory and the computer program code are configured to, with the at least one processor, cause the second network device at least to transmit information identifying a cell of the first non-terrestrial network to the user device for the user device to use the information to monitor paging messages of the cell of the first non-terrestrial network.

In an example embodiment, the first non-terrestrial network is based on geostationary Earth orbit satellites and the second non-terrestrial network is based on low-Earth orbit satellites.

According to a fourth aspect, a core network for non-terrestrial communication is provided. The core network is configured to receive data to be sent to a user device; transmit paging information associated with the user device to a first network device of a first non-terrestrial network; and transmit to a second network device of a second non-terrestrial network the user data to be transmitted to the user device by the second network device.

In an example embodiment, the core network is configured to maintain mapping information providing a mapping between a tracking area of the first non-terrestrial network and tracking areas of the second non-terrestrial network.

In an example embodiment, the core network is configured to transmit, based on the mapping information, an indication to a network device of the first non-terrestrial network that the user device can be paged by the network device.

In an example embodiment, the core network is configured to transmit the user data to a plurality of second network devices of the second non-terrestrial network.

In an example embodiment, the first non-terrestrial network is based on geostationary Earth orbit satellites and the second non-terrestrial network is based on low-Earth orbit satellites.

According to a fifth aspect, a method for non-terrestrial network communication is provided. The method comprises receiving, by a user device, a paging message from a first network device associated; and in response to the paging message, initiating, by the user device, a random access procedure with a second network device associated with a second non-terrestrial network to establish a radio resource connection with the second network device.

According to a sixth aspect, a method for non-terrestrial network communication is provided. The method comprises transmitting, by a first network device of a first non-terrestrial network, information identifying a user device to a second network device of a second non-terrestrial network; and transmitting, by the first network device, a paging message to the user device, the paging message causing the user device to initiate a random access procedure with the second network device.

According to a seventh aspect, a method for non-terrestrial network communication is provided. The method comprises receiving, by a second network device of a second non-terrestrial network from a first network device of a first non-terrestrial network, information identifying a user device; obtaining, by the second network device, user plane data associated with the user device; receiving, by the second network device, a random access procedure request from the user device to establish a radio resource connection with the user device; and transmitting, by the second network device, a random access procedure response to the user device.

According to an eighth aspect, a method for non-terrestrial network communication is provided. The method comprises receiving, by a core network, data to be sent to a user device; transmitting, by the core network, paging information associated with the user device to a first network device of a first non-terrestrial network; and transmitting, by the core network, to a second network device of a second non-terrestrial network the user data to be transmitted to the user device by the second network device.

According to a ninth aspect, a computer program comprises instructions for causing a user device to perform at least the following: receiving, by a user device, a paging message from a first network device associated; and in response to the paging message, initiating, by the user device, a random access procedure with a second network device associated with a second non-terrestrial network to establish a radio resource connection with the second network device.

According to a tenth aspect, a computer program comprises instructions for causing a first network device of a first non-terrestrial network to perform at least the following: transmitting, by the first network device of a first non-terrestrial network, information identifying a user device to a second network device of a second non-terrestrial network; and transmitting, by the first network device, a paging message to the user device, the paging message causing the user device to initiate a random access procedure with the second network device.

According to an eleventh aspect, a computer program comprises instructions for causing a second network device of a second non-terrestrial network to perform at least the following: receiving, by the second network device of a second non-terrestrial network from a first network device of a first non-terrestrial network, information identifying a user device; obtaining, by the second network device, user plane data associated with the user device; receiving, by the second network device, a random access procedure request from the user device to establish a radio resource connection with the user device; and transmitting, by the second network device, a random access procedure response to the user device.

According to a twelfth aspect, a computer program comprises instructions for causing an apparatus of a core network to perform at least the following: receiving, by the apparatus, data to be sent to a user device; transmitting, by the apparatus, paging information associated with the user device to a first network device of a first non-terrestrial network; and transmitting, by the apparatus, to a second network device of a second non-terrestrial network the user data to be transmitted to the user device by the second network device.

According to a thirteenth aspect, a user device for non-terrestrial network communication may comprise means for: receiving a paging message from a first network device associated; and in response to the paging message, initiating a random access procedure with a second network device associated with a second non-terrestrial network to establish a radio resource connection with the second network device.

According to a fourteenth aspect, a first network device of a first non-terrestrial network may comprise means for: transmitting information identifying a user device to a second network device of a second non-terrestrial network; and transmitting a paging message to the user device, the paging message causing the user device to initiate a random access procedure with the second network device.

According to a fifteenth aspect, a second network device of a second non-terrestrial network may comprise means for: receiving, from a first network device of a first non-terrestrial network, information identifying a user device; obtaining user plane data associated with the user device; receive a random access procedure request from the user device to establish a radio resource connection with the user device; and transmitting a random access procedure response to the user device.

According to a sixteenth aspect, a core network for non-terrestrial communication is provided. The core network may comprises means for: receiving data to be sent to a user device; transmitting paging information associated with the user device to a first network device of a first non-terrestrial network; and transmitting to a second network device of a second non-terrestrial network the user data to be transmitted to the user device by the second network device.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to understand the example embodiments.

In the drawings:

FIG. 1 illustrates an example of a method for non-terrestrial network communication according to an example embodiment.

FIG. 2 illustrates an example of a method for non-terrestrial network communication according to another example embodiment.

FIG. 3 illustrates an example of a method for non-terrestrial network communication according to another example embodiment.

FIG. 4 illustrates an example of a method for non-terrestrial network communication according to another example embodiment.

FIG. 5 illustrates a signaling diagram for non-terrestrial network communication according to an example embodiment.

FIG. 6 illustrates an example of an apparatus configured to practice one or more example embodiments.

FIG. 7 illustrates an example of an apparatus configured to practice one or more example embodiments.

Like references are used to designate like parts in the accompanying drawings.

### DETAILED DESCRIPTION

Reference will now be made in detail to example embodiments, examples of which are illustrated in the accompanying drawings. The detailed description provided below in connection the appended drawings is intended as a description of the present examples and is not intended to represent the only forms, in which the present example may be constructed or utilized. The description sets forth the functions of the example and the sequence of steps for constructing and operating the example. However, the same or equivalent functions and sequences may be accomplished by different examples.

Various examples and embodiments discussed below illustrate a solution relating to communication in non-terrestrial networks having different network characteristics. In the solution a first non-terrestrial network is used to page a user device, and a second non-terrestrial network is then used the initiate data communication with the user device. The first non-terrestrial network may comprise geostationary Earth orbit (GEO) satellites and the second non-terrestrial network may comprises low-Earth orbit (LEO) satellites. The GEO satellites are far from Earth (approx. 36000 km) leading, for example, to large delays and a poor link budget. On the other hand, the LEO satellites may be moving fast relative to Earth (7.5 km/s). This means that the coverage on Earth may be changing with the movement of the satellite. Alternatively, with Earth fixed cells, a cell coverage may be kept constant for as long as possible by steering the satellite beam to the same spot on Earth. When this is not possible any more, a new satellite will take over the same spot. In any case, this may mean that user devices on Earth will experience frequent mobility events in both active (handovers) and inactive (cell reselections) mode causing, for example, an increased power consumption at user devices. The illustrated solution makes use of advantages of the two non-terrestrial networks by splitting different actions to the two different networks.

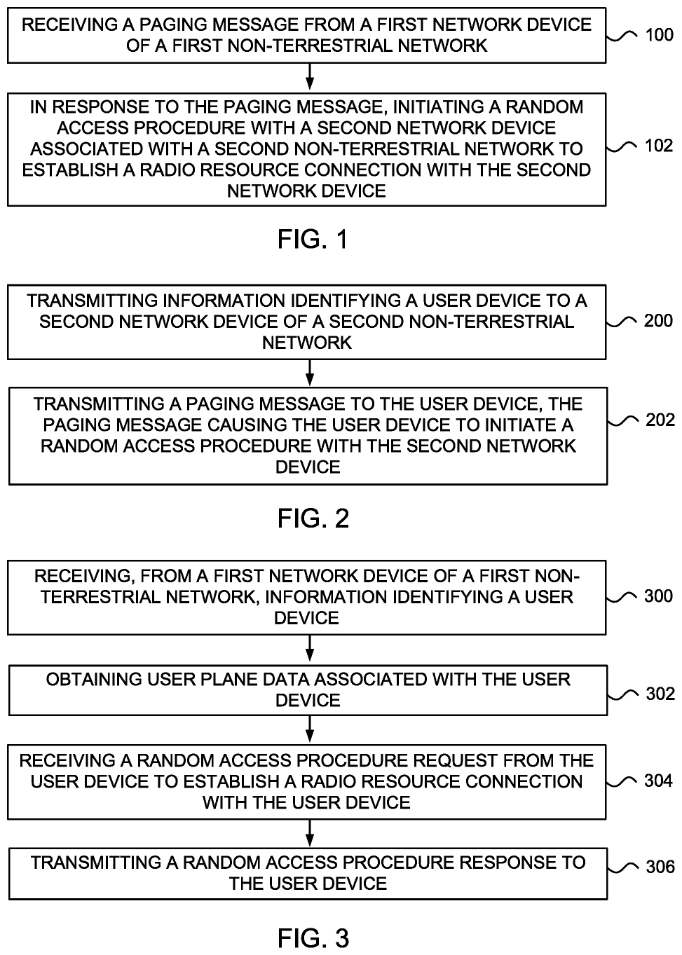

FIG. 1 illustrates an example of a method for non-terrestrial network communication according to another example embodiment. The method may be implemented, for example, by a user device or user equipment.

At 100 the user device may receive a paging message from a first network device of a first non-terrestrial network. The first network device may be a base station or a gNB. The first non-terrestrial network may comprise one or more GEO satellites.

At 102 in response to the paging message, the user device may initiate a random access procedure with a second network device associated with a second non-terrestrial network to establish a radio resource connection with the second network device. The second network device may be a base station or a gNB. The second non-terrestrial network may comprise one or more LEO satellites. As the coverage provided by the second non-terrestrial network is not moving with respect to the user device, it is more beneficial to use it to the paging functionality. On the other hand, as the throughput both in uplink and downlink directions is better with the first non-terrestrial network, it is more beneficial to use it for the actual data transmission.

FIG. 2 illustrates an example of a method for non-terrestrial network communication according to an example embodiment. The method may be performed by a first network device of a first non-terrestrial network. The first network device may comprise, for example, a base station or a gNB, and the first non-terrestrial network may comprise one or more GEO satellites.

At 200 the first network device may transmit information identifying a user device to a second network device of a second non-terrestrial network. This information then enables the second network device to be aware of the user device that will try to connect with the second network device.

At 202 the first network device may transmit a paging message to the user device, the paging message causing the user device to initiate a random access procedure with the second network device. The paging message may act as an indication for the first network device to initiate the random access procedure with the second network device. As the uplink throughput from the user device towards the first network device may be limited or even non-existent, the paging message from the first network device to the user device enables the user device to initiate the random access procedure with the second network device which is able to offer better data throughput.

FIG. 3 illustrates an example of a method for non-terrestrial network communication according to an example embodiment. The method may be performed by a second network device of a second non-terrestrial network. The second network device may comprise, for example, a base station or a gNB, and the second non-terrestrial network may comprise one or more LEO satellites.

At 300 the second network device may receive, from a first network device of a first non-terrestrial network, information identifying a user device.

At 302 the second network device may obtain user plane data associated with the user device. The user plane data may be received, for example, directly from a core network.

At 304 the second network device may receive a random access procedure request from the user device to establish radio resource connection with the user device.

At 306 the second network device may transmit a random access procedure response to the user device to initiate a radio resource control (RRC) connection. As the uplink throughput from the user device towards the second network device is better than towards the first network device, it is more beneficial to establish the uplink connection from the user device by using the first network device.

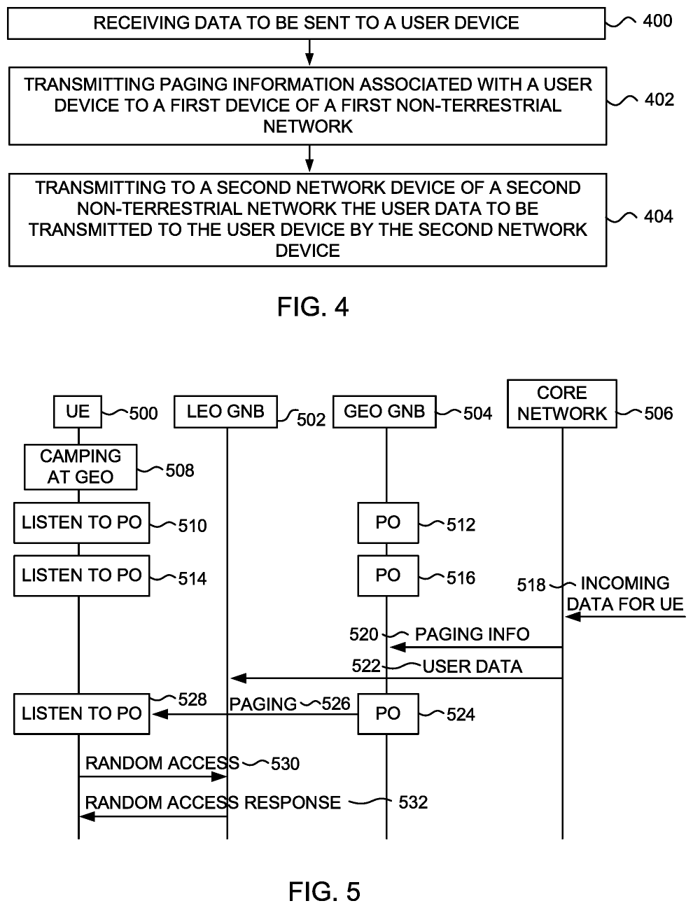

FIG. 4 illustrates an example of a method for non-terrestrial network communication according to an example embodiment. The method may be performed by a core network associated with a non-terrestrial network.

At 400 the core network may receive incoming data to be sent to a user device.

At 402 the core network may transmit paging information associated with the user device to a first network device of a first non-terrestrial network. The paging information may comprise an identifier identifying the user device.

At 404 the core network may transmit to a second network device of a second non-terrestrial network the user data to be transmitted to the user device by the second network device. This enables a solution in which, instead of trying to send user data to the user node with the first network device, the first network device is used for the data transfer as it is better suited for this purpose.

FIG. 5 illustrates a signaling diagram for non-terrestrial network communication according to an example embodiment.

A user device 500 may be configured to camp at a GEO network, i.e. a first non-terrestrial network, as it is more power efficient for the user device 500 to camp at the GEO network than at a LEO network. The term “camp” used herein may refer to an idle mode in which there is no exchange of messages required between the user device 500 and the GEO gNB 504. The user device may be configured to listen 510, 514 predetermined paging occasions 512, 516 from a first network device, i.e. a GEO gNB 504.

At some point of time, a core network 506 may, at 518, receive incoming data for the user device 500. In response to this, the core network 506 may, at 520, transmit paging information to the GEO gNB 504 in order to initiate a paging procedure with the GEO gNB 504. The paging information may comprise an identifier of the user device 500. The core network may, at 522, also transmit the user data to a LEO gNB 502 or alternatively to a group of LEO gNBs that are in the area covering the same tracking area associated with the GEO gNB 504.

At 524 the GEO gNB 504 may again initiate a paging occasion and now it is configured to transmit, at 526, a paging message to the user device 500. At 528 the user device 500 again listens to the paging occasion and receives the paging message from the LEO gNB 502. The paging message may comprise an indication of the LEO gNB 502. In another example embodiment, the LEO gNB 502 may be preconfigured in the user device 500.

Upon the reception of the paging message, the user device 500 may detach from the GEO gNB 504, reads the parameters of the cell conveyed by the LEO gNB 502, and initiates, at 530, a radio resource control (RRC) connection via a random access. At 532 the LEO gNB 502 may transmit a random access response to the user device 500. In an example embodiment, the LEO gNB 502 may be aware that the user device connecting is the user device for which the user data earlier received from the core network 506 is meant. Information about the user device may have been exchanged between the LEO gNB 502 and GEO gNB 506 via the Xn interface if they are on the same system, or using other means if they are different systems.

In an example embodiment, when connected to the LEO gNB 502, the user device 502 may perform its data transmission and reception. When the data transmission/reception is finished, the user device 500 may move back to the GEO network to camp on.

In an example embodiment, the user device 500 may be informed about the gNB to camp on after disconnecting the connection with the LEO gNB 502. While still being active with the LEO gNB 502 and before disconnecting the connection with the LEO gNB 502, the user device 500 may be configured to receive from the LEO gNB 502 information regarding a tracking Area (or group of tracking areas) it is on belonging to the GEO network, and a corresponding GEO cell to camp on after connection with the LEO gNB 502 has been terminated. In an example embodiment, the network may guess the GEO cell in which the UE is camped at based on the tracking area code. The network may even skip the normal procedure of paging the user device first in the last cell the user device was active on (i.e. the LEO gNB 502).

In an example embodiment, as the tracking areas relating to LEO and GEO are fixed to Earth, there exists always a one to one or one to many tracking area mapping between GEO and LEO cells. This mapping can be performed in one of the core networks (in the AMF) with or without help of the satellite control function.

In an example embodiment, the GEO network may broadcast a list of tracking areas of the LEO network corresponding to a tracking area of the GEO network to the device 500. The mapping between the LEO and GEO tracking areas may be maintained by the core network, for example, by an access and mobility management function (AMF).

In an example embodiment, the GEO and LEO may not belong to the same operator/network. In this case, agreements between all parts may be implemented beforehand, which includes the user device, the GEO network and the LEO network. For example, the LEO network may provide the user device with information about the GEO cell, for example, a public land mobile network, a cell identifier, a tracking area etc. The user device then may camp on this GEO cell and actively listen to its paging information. In the situation the device is to be paged, a mobility management entity (MME) of the origin network (i.e. the LEO operator) may send to the GEO operator the identifiers associated with this user device. In another example embodiment, for secrecy reasons, the identifier may be a temporary identifier created just for this purpose.

In an example embodiment, the AMF may prepare the user data forwarding to several base stations, similarly to the case of a conditional handover. Then, instead of the handover message from the gNB, the access message may be the trigger for the user data forwarding. In another example embodiment, there may be early data transfer (as in the case of a conditional handover) to different gNBs.

In an example embodiment, there may be a mapping between the paging occasions and the LEO cells that are common to a given tracking area. There may be different paging occasions in a system. A paging indication may be used to indicate in which cell the data will come or to which cell a user device should connect. For example, if there are two potential LEO cells, if a UE is paged in every second paging occasion it should access cell 2 and otherwise cell 1.

In an example embodiment, non-critical extensions in the paging message may be used to convey in which cell the user device is waited for. This may at the same time enhance the paging to provide a contention-free access in the LEO cell. If the user device cannot see this cell, it may start from a new cell.

One or more of the examples and/or embodiments discussed above may prevent several cell reselections that would happen, if the user device was camped in the fast moving LEO cells. One or more of the examples and/or embodiments discussed above may minimize the “signal chasing” performed, when the user device wakes up to listen to LEO cells. The frequency doppler offset in a downlink LEO may vary from 0 to dozens of SCS, and this increases significantly the search space for the user device, thus increasing the wake-up time and the processor energy consumption. One or more of the examples and/or embodiments discussed above may prevent the user device to try the random-access channel (RACH) to the GEO cell, which would require the usage of coverage enhancement and several repetitions. One or more of the examples and/or embodiments discussed above may make the paging process easier, and by minimizing the search space of the user device, it may help minimizing the time for the UE to comply with the paging message request for a RRC setup.

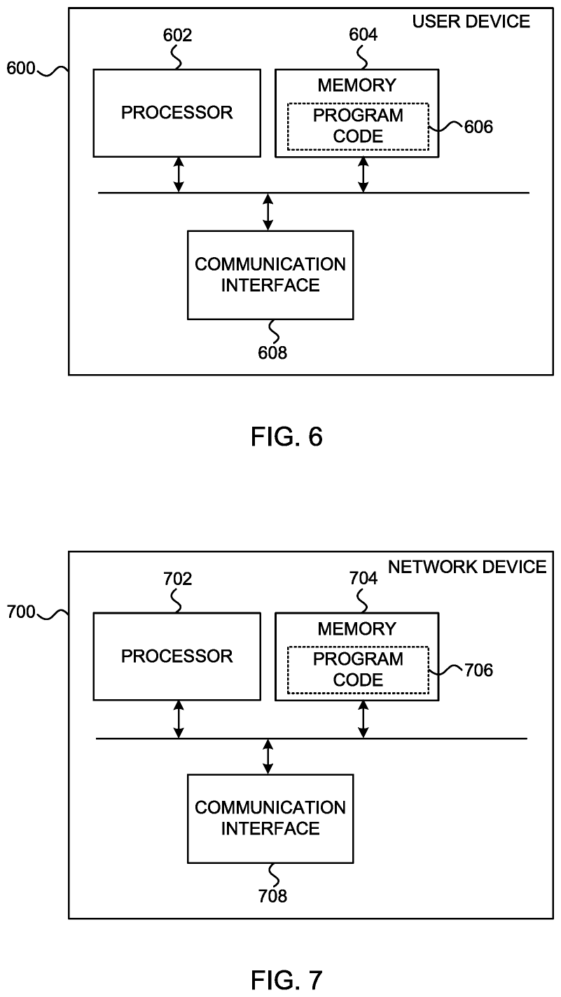

FIG. 6 illustrates an example of an apparatus 600 configured to practice one or more example embodiments. The apparatus 600 may comprise at least one processor 602. The at least one processor 602 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, special-purpose computer chip, or the like.

The apparatus 600 may further comprise at least one memory 604. The at least one memory 604 may be configured to store, for example, computer program code or the like, for example, operating system software and application software. The at least one memory 604 may comprise one or more volatile memory devices, one or more non-volatile memory devices, and/or a combination thereof. For example, the at least one memory 604 may be embodied as magnetic storage devices (such as hard disk drives, floppy disks, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise a communication interface 608 configured to enable apparatus 600 to transmit and/or receive information to/from other devices. In one example, the apparatus 600 may use the communication interface 608 to transmit or receive signaling information and data in accordance with at least one data communication or cellular communication protocol. The communication interface 608 may be configured to provide at least one wireless radio connection, such as, for example, a 3GPP mobile broadband connection (e.g. 3G, 4G, 5G, 6G etc.). In another example embodiment, the communication interface 608 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 600 is configured to implement some functionality, some component and/or components of the apparatus 600, for example, the at least one processor 602 and/or the at least one memory 604, may be configured to implement this functionality. Furthermore, when the at least one processor 602 is configured to implement some functionality, this functionality may be implemented using the program code 606 comprised, for example, in the at least one memory 604.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 600 may comprise, for example, a computing device, for example, a mobile device, a mobile phone, a user device, a user equipment, a user node, a tablet computer, a laptop, an internet of things (IoT) device, a tag, or the like. Examples of IoT devices include, but are not limited to, consumer electronics, wearables, sensors, and smart home appliances. Although the apparatus 600 is illustrated as a single device it is appreciated that, wherever applicable, functions of the apparatus 600 may be distributed to a plurality of devices, for example, to implement example embodiments as a cloud computing service.

An apparatus, for example, a device such as a mobile device, a mobile phone, a user device, a user equipment, a user node, a tablet computer, a laptop, an internet of things (IoT) device, or a tag, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus 600 may comprise means for performing any aspect of the method(s) described herein. According to an example embodiment, the means may comprise at least one processor, and at least one memory including program code, the at least one processor, and program code configured to, when executed by the at least one processor, cause performance of any aspect of the method(s).

FIG. 7 illustrates an example of an apparatus 700 configured to practice one or more example embodiments. The apparatus 700 may comprise at least one processor 702. The at least one processor 702 may comprise, for example, one or more of various processing devices or processor circuitry, such as, for example, a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 700 may further comprise at least one memory 704. The at least one memory 704 may be configured to store, for example, computer program code or the like, for example, operating system software and application software. The at least one memory 704 may comprise one or more volatile memory devices, one or more non-volatile memory devices, and/or a combination thereof. For example, the at least one memory 704 may be embodied as magnetic storage devices (such as hard disk drives, floppy disks, magnetic tapes, etc.), optical magnetic storage devices, or semiconductor memories (such as mask (programmable ROM), EPROM (erasable PROM), ROM, PROM flash ROM, RAM (random access memory), etc.).

The apparatus 700 may further comprise a communication interface 708 configured to enable apparatus 700 to transmit and/or receive information to/from other devices. In one example, the apparatus 700 may use the communication interface 708 to transmit or receive signaling information and data in accordance with at least one data communication or cellular communication protocol. The communication interface 708 may be configured to provide at least one wireless radio connection, such as, for example, a 3GPP mobile broadband connection (e.g. 3G, 4G, 5G, 6G etc.). In another example embodiment, the communication interface 708 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection, for example, a local area network (LAN) connection, a universal serial bus (USB) connection or an optical network connection, or the like; or wired a Internet connection. The communication interface 708 may comprise, or be configured to be coupled to, at least one antenna to transmit and/or receive radio frequency signals. One or more of the various types of connections may be also implemented as separate communication interfaces, which may be coupled or configured to be coupled to one or more of a plurality of antennas.

When the apparatus 700 is configured to implement some functionality, some component and/or components of the apparatus 700, for example, the at least one processor 702 and/or the at least one memory 704, may be configured to implement this functionality. Furthermore, when the at least one processor 702 is configured to implement some functionality, this functionality may be implemented using the program code 606 comprised, for example, in the at least one memory 704.

The functionality described herein may be performed, at least in part, by one or more computer program product components such as software components. According to an embodiment, the apparatus may comprise a processor or processor circuitry, for example, a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), application-specific Integrated Circuits (ASICs), application-specific Standard Products (ASSPs), System-on-a-chip systems (SOCs), Complex Programmable Logic Devices (CPLDs), and Graphics Processing Units (GPUS).

The apparatus 700 may comprise, for example, a computing device, for example, a base station, a server, a network node, a cloud node or the like. Although the apparatus 700 is illustrated as a single device it is appreciated that, wherever applicable, functions of the apparatus 700 may be distributed to a plurality of devices, for example, to implement example embodiments as a cloud computing service.

An apparatus, for example, a device such as a base station, a server, a network node, or a cloud node, may be configured to perform or cause performance of any aspect of the method(s) described herein. Further, a computer program may comprise instructions for causing, when executed, an apparatus to perform any aspect of the method(s) described herein. The computer program may be stored on a computer-readable medium. Further, the apparatus 700 may comprise means for performing any aspect of the method(s) described herein. According to an example embodiment, the means may comprise at least one processor, and at least one memory including program code, the at least one processor, and program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps or operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. A user device (500, 600) for non-terrestrial network communication, the user device (500, 600) comprising:
at least one processor (602); and
at least one memory (604) including computer program code (606), the at least one memory (504) and the computer program code (606) configured to, with the at least one processor (602), cause the user device (500, 600) at least to:
receive a paging message from a first network device (504) of a first non-terrestrial network; and
in response to the paging message, initiate a random access procedure with a second network device (502) associated with a second non-terrestrial network to establish a radio resource connection with the second network device (502).

2. The user device (500, 600) according to claim 1, wherein the at least one memory (604) including computer program code (606), the at least one memory (604) and the computer program code (606) are configured to, with the at least one processor (602), cause the user device (500, 600) at least to:
before terminating the radio resource connection with the second network device (502), receive information identifying a cell of the first non-terrestrial network from the second network device (502);
terminate the radio resource connection with the second network device (502); and
monitor paging messages of the cell of the first non-terrestrial network.

3. The user device (500, 600) according to claim 1 or 2, wherein the paging message comprises an indication of at least one cell of the second non-terrestrial network.

4. The user device (500, 600) according to claim 1 or 2, wherein the at least one memory (604) including computer program code (606), the at least one memory (604) and the computer program code (606) are configured to, with the at least one processor (602), cause the user device (500, 600) at least to:
in response to receiving the paging message, obtain preconfigured information about the second network device (502) with which to initiate the random access procedure.

5. The user device (500, 600) according to any of claims 1-4, wherein the first non-terrestrial network is based on geostationary Earth orbit satellites and the second non-terrestrial network is based on low-Earth orbit satellites.

6. A first network device (504, 700) of a first non-terrestrial network for non-terrestrial network communication, the first network device (504, 700) comprising:
at least one processor (702); and
at least one memory (704) including computer program code (706), the at least one memory (704) and the computer program code (706) configured to, with the at least one processor (702), cause the first network device (504, 700) at least to:
transmit information identifying a user device (500, 600) to a second network device (502) of a second non-terrestrial network; and
transmit a paging message to the user device (500, 600), the paging message causing the user device (500, 600) to initiate a random access procedure with the second network device (502).

7. The first network device (504, 700) according to claim 6, the paging message comprises an indication of at least one cell of the second non-terrestrial network.

8. The first network device (504, 700) according to claim 6 or 7, wherein the at least one memory (704) including computer program code (706), the at least one memory (704) and the computer program code (606) are configured to, with the at least one processor (702), cause first the network device (504, 700) at least to
receive, a from core network (506), mapping information providing a mapping between a tracking area of the first non-terrestrial network and tracking areas of the second non-terrestrial network; and
transmit the mapping information to the user device (500, 600).

9. The first network device (504, 700) according to any of claims 6-8, wherein the first non-terrestrial network is based on geostationary Earth orbit satellites and the second non-terrestrial network is based on low-Earth orbit satellites.

10. A second network device (502, 700) of a second non-terrestrial network for non-terrestrial network communication, the second network device (502, 700) comprising:
at least one processor (702); and
at least one memory (704) including computer program code (706), the at least one memory (704) and the computer program code (706) configured to, with the at least one processor (702), cause the second network device (502, 700) at least to:
receive, from a first network device (504) of a first non-terrestrial network, information identifying a user device (500, 600);
obtain user plane data associated with the user device (500, 600);
receive a random access procedure request from the user device (500, 600) to establish a radio resource connection with the user device (500, 600); and
transmit a random access procedure response to the user device (500, 600).

11. The second network device (502, 700) according to claim 10, wherein the at least one memory (704) including computer program code (706), the at least one memory (704) and the computer program code (706) are configured to, with the at least one processor (702), cause the second network device (502, 700) at least to:
transmit information identifying a cell of the first non-terrestrial network to the user device (500, 600) for the user device (500, 600) to use the information to monitor paging messages of the cell of the first non-terrestrial network.

12. The second network device (502, 700) according to any of claims 10-11, wherein the first non-terrestrial network is based on geostationary Earth orbit satellites and the second non-terrestrial network is based on low-Earth orbit satellites.

13. A core network (506) for non-terrestrial communication configured to:
receive data to be sent to a user device (500, 600);
transmit paging information associated with the user device (500, 600) to a first network device (504) of a first non-terrestrial network; and
transmit to a second network device (502) of a second non-terrestrial network the user data to be transmitted to the user device (500, 600) by the second network device (502).

14. The core network (506) according to claim 13, wherein the core network (506) is configured to maintain mapping information providing a mapping between a tracking area of the first non-terrestrial network and tracking areas of the second non-terrestrial network.

15. The core network (506) according to claim 14, wherein the core network (506) is configured to transmit, based on the mapping information, an indication to a network device of the first non-terrestrial network that the user device (500, 600) can be paged by the network device.

16. The core network (506) according to any of claims 13-15, wherein the core network (506) is configured to transmit the user data to a plurality of second network devices (502) of the second non-terrestrial network.

17. The core network (506) according to any of claims 13-16, wherein the first non-terrestrial network is based on geostationary Earth orbit satellites and the second non-terrestrial network is based on low-Earth orbit satellites.

18. A method for non-terrestrial network communication, the method comprising:
receiving, by a user device (500, 600), a paging message from a first network device (504) of a first non-terrestrial network; and
in response to the paging message, initiating, by the user device (500, 600), a random access procedure with a second network device (502) associated with a second non-terrestrial network to establish a radio resource connection with the second network device (502).

19. A method for non-terrestrial network communication, the method comprising:
transmitting, by a first network device (504) of a first non-terrestrial network, information identifying a user device (500, 600) to a second network device (502) of a second non-terrestrial network; and
transmitting, by the first network device (504), a paging message to the user device (500, 600), the paging message causing the user device (500, 600) to initiate a random access procedure with the second network device (502).

20. A method for non-terrestrial network communication, the method comprising:
receiving, by a second network device (502) of a second non-terrestrial network from a first network device (504) of a first non-terrestrial network, information identifying a user device (500, 600);
obtaining, by the second network device (502), user plane data associated with the user device (500, 600);
receiving, by the second network device (502), a random access procedure request from the user device (500, 600) to establish a radio resource connection with the user device (500, 600); and
transmitting, by the second network device (502), a random access procedure response to the user device (500, 600).

21. A method for non-terrestrial network communication, the method comprising:
receiving, by a core network (506), data to be sent to a user device (500, 600);
transmitting, by the core network (506), paging information associated with the user device (500, 600) to a first network device (504) of a first non-terrestrial network; and
transmitting, by the core network (506), to a second network device (502) of a second non-terrestrial network the user data to be transmitted to the user device (500, 600) by the second network device (502).

22. A computer program comprising instructions for causing a user device (500, 600) to perform at least the following:
receiving, by a user device (500, 600), a paging message from a first network device (504) of a first non-terrestrial network; and
in response to the paging message, initiating, by the user device (500, 600), a random access procedure with a second network device (502) associated with a second non-terrestrial network to establish a radio resource connection with the second network device (502).

23. A computer program comprising instructions for causing a first network device (504) of a first non-terrestrial network to perform at least the following:
transmitting, by the first network device (504) of a first non-terrestrial network, information identifying a user device (500, 600) to a second network device (502) of a second non-terrestrial network; and
transmitting, by the first network device (504), a paging message to the user device (500, 600), the paging message causing the user device (500, 600) to initiate a random access procedure with the second network device (502).

24. A computer program comprising instructions for causing a second network device (502) of a second non-terrestrial network to perform at least the following:
receiving, by the second network device (502) of a second non-terrestrial network from a first network device (504) of a first non-terrestrial network, information identifying a user device (500, 600);
obtaining, by the second network device (502), user plane data associated with the user device (500, 600);
receiving, by the second network device (502), a random access procedure request from the user device (500, 600) to establish a radio resource connection with the user device (500, 600); and
transmitting, by the second network device (502), a random access procedure response to the user device (500, 600).

25. A computer program comprising instructions for causing an apparatus of a core network (506) to perform at least the following:
receiving, by the apparatus, data to be sent to a user device (500, 600);
transmitting, by the apparatus, paging information associated with the user device (500, 600) to a first network device (504) of a first non-terrestrial network; and
transmitting, by the apparatus, to a second network device (502) of a second non-terrestrial network the user data to be transmitted to the user device (500, 600) by the second network device (502).
